(19) United States
(12) Patent Application Publication
(10) Pub. No.: US 2002/0181678 A1
(43) Pub. Date: Dec. 5, 2002

(54) Data transmission method by automatic frequency control

(76) Inventors: Cheng-Shing Lai, Taipei (TW); Xu-Wei Tu, Nanjing (CN); Hong Ding, Nanjing (CN)

Correspondence Address: BIRCH STEWART KOLASCH & BIRCH, PO BOX 747, FALLS CHURCH, VA, 22040-0747, US

(21) Appl. No.: 09/873,181

(22) Filed: Jun. 5, 2001

(51) Int. Cl. H04M 11/00; H04M 1/00; H04B 1/38

(52) U.S. Cl. 379/93.32; 379/93.33; 455/557

(57) ABSTRACT

The specification discloses a data transmission method by automatic frequency control, which automatically selects an optimal data transmission rate between a data-sending end (such as a personal computer) and a mobile phone. An automatic frequency control mechanism (program) is provided at the data-sending end that can automatically change the data transmission rate. Through the communications and protocol between the data-sending end and the mobile phone, the automatic frequency control mechanism starts to look for the highest transmission rate that both of them can reliably transmit data through a cable before transmitting data. Afterwards, real data transmission operations start so as to achieve the goal of transmitting data in the fastest speed and the shortest time.

### BACKGROUND OF THE INVENTION

1. Field of Invention

The invention relates to a method of data transmission using a cable between a data-sending end and a mobile phone and, in particular, to a method that can automatically find out the fastest and most reliable data transmission rate.

2. Related Art

Current mobile communication products mostly refer to mobile phones. In addition to superior communication qualities, they contain a variety of other more convenient human-machine interfaces and additional functions (e.g., online updating programs, games, etc). Integrating the strong data management function of personal digital assistants (PDAs) and network functions is the trend for such products in the future.

A user can download updated program code from a network through a PC and use a data transmission cable (such as serial cables) to transmit the new program code to a mobile phone to complete the program update or function upgrade. For example, the user can download new ringing tones and new startup screens and update the system.

Currently, in the operation of data transmission between a PC and a mobile phone, the transmission rate (Baud rate) is chosen to be the lowest, such as 38.4K, in order to ensure the success and reliability of data transmission. However, for the original hardware design, the allowed data transmission rate is much greater than the above value. Laboratory tests find that the currently used serial cables can reach 115.2K Baud rate. The reason for choosing a lower transmission rate is in consideration of the length and quality of the serial cable or hardware environment that may influence or lower the transmission rate. This is why most systems choose a conservative lower transmission rate to perform data transmission. Although abandoning higher transmission rates can ensure the success and reliability of data transmission, it makes the transmission time much longer. Compared with data transmissions at higher Baud rates, the prior art indeed waste some precious time of users.

### SUMMARY OF THE INVENTION

It is a primary object of the invention to solve the above problem by finding the highest and reliable data transmission rate for a cable between a data-sending end and a mobile phone to shorten the data transmission time.

It is another object of the invention to minimize the time needed for updating programs (executive code update) in a mobile phone.

Pursuant to the disclosed method, a fastest and reliable data transmission Baud rate is searched from the highest Baud rate supported by both a mobile phone and a data-sending end downwards through the communications between the mobile phone and the data-sending end before the data transmission starts. The Baud rate thus found is used as the data transmission Baud rate for real data transmission.

### BRIEF DESCRIPTION OF THE DRAWINGS

The present invention will become more fully understood from the detailed description given hereinbelow illustration only, and thus are not limitative of the present invention, and wherein:

FIG. 1 is a block diagram of the hardware composition of the invention;

FIG. 2 is a flowchart of the main steps in the invention;

FIG. 3 is a flowchart of partial steps in the invention; and

FIG. 4 is another flowchart of partial steps in the invention.

### DETAILED DESCRIPTION OF THE INVENTION

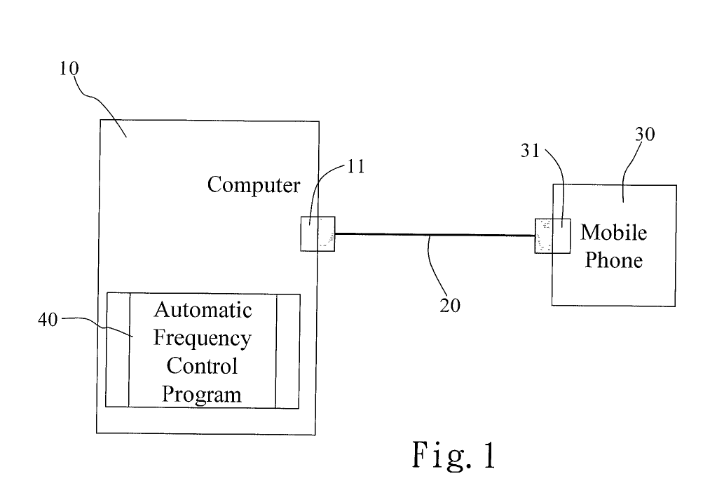

With reference to FIG. 1, hardware equipment for implementing the disclosed method includes a computer 10, a serial cable 20, a mobile phone 30 and an automatic frequency control program 40.

The computer 10, such as a desktop personal computer (PC) or a notebook (NB) computer, stores the upgrade program (or executive code) for updating the mobile phone 30 and the automatic frequency control program 40. The upgrade program can be obtained by linking to and downloading from a network (such as the Internet or the world wide web). It can also be copied to the computer 10 by a programmer using other methods (from a computer readable recording medium such as a hard disk drive, an optical disk drive, a floppy disk drive).

The mobile phone 30 contains at least one connection port 31 that supports the standard serial communications and connects to a serial port 11 of the computer 10 through a serial cable 20 to receive the upgrade program from the computer 10.

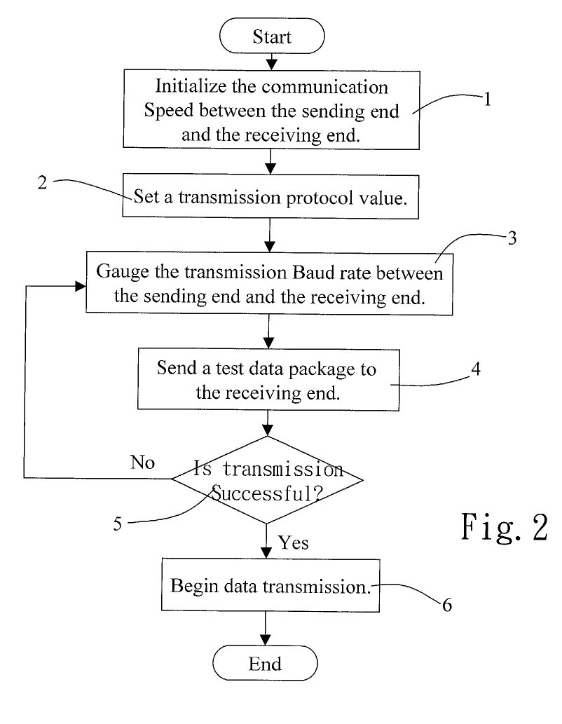

The invention uses the automatic frequency control program 40 to implement the automatic frequency control data transmission method between the computer 10 (hereinafter as the sending end) and the mobile phone 30 (hereinafter as the receiving end). The main steps are illustrated in FIG. 2, including:

1. the step of initializing the communication speed between the sending end and the receiving end to ensure both ends can correctly communicate with each other;

2. the step of setting a transmission protocol value to determine an initial optimal transmission Baud rate for searching;

3. the step of gauging the transmission Baud rate between the sending end and the receiving end to reset the transmission Baud rate as the transmission protocol value;

4. the step of sending a test data package from the sending end to the receiving end;

5. the step of checking whether step 4 is successful, and lowering and updating the transmission protocol value and returning to step 3 if it is not successful or continuing to the next step otherwise; and

6. the step of starting data transmission, which starts to send data packages from the sending end to the receiving end using the transmission Baud rate determined by the transmission protocol value.

Step 1 mainly sets equal the transmission Baud rates of the sending end and the receiving end. This transmission Baud rate is called the initial Baud rate, which is usually the lowest transmission Baud rate allowed by the hardware, e.g., 38.4K. Step 2 mainly selects the highest transmission Baud rate allowed by the hardware as the transmission protocol value to search the fastest and most reliable transmission Baud rate downward from the highest transmission Baud rate. Step 6 can further include the step of using the cyclical redundancy check (CRC) method to ensure the correctness of the transmitted data packages.

The CRC method is a well-known algorithm in verifying the correctness after data transmission. For example, Xmomdem, X.25, SDLC, Ethernet, and Token Ring all use this method to check the transmitted data. This method is also used to check compressed data in zipped files.

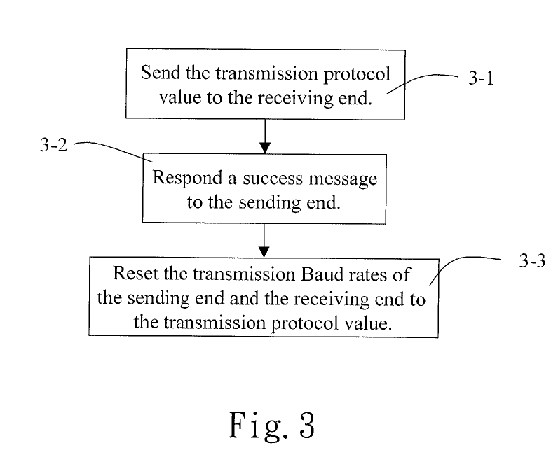

With reference to FIG. 3, step 3 includes the following steps of:

3-1. sending an information package that contains the transmission protocol value from the sending end to the receiving end;

3-2. responding the sending end successful setting information after the receiving end correctly receives the information package; and

3-3. resetting the transmission protocol value as the current transmission Baud rates of the sending end and the receiving end.

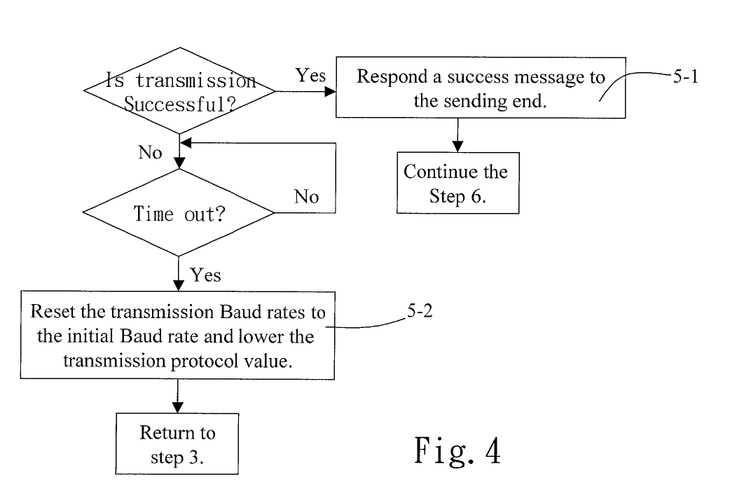

With reference to FIG. 4, step 5 includes the steps of:

5-1. responding successful data transmission information to the sending end after the receiving end receives the test data package correctly, indicating that the gauged transmission Baud rate between both ends can correctly and reliably transmit data, and continuing to step 6; and

5-2. resetting the transmission Baud rate of the sending end and the receiving end to the initial Baud rate (38.4K) if the sending end does not receive successful data transmission information from the receiving end within a predetermined waiting time (time out), then lowering and updating the transmission protocol value and returning to step 3, thus resetting the transmission Baud rates on both ends under the condition that both ends can still communicate with each other.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An automatic frequency control data transmission method to automatically select an optimal data transmission rate for a cable connecting a data-sending end and a mobile phone, which comprises the steps of:
A. initializing the communication speed between the sending end and the receiving end to ensure both ends can correctly communicate with each other;
B. setting a transmission protocol value to determine an initial optimal transmission Baud rate for searching;
C. gauging the transmission Baud rate between the sending end and the receiving end to reset the transmission Baud rate as the transmission protocol value;
D. sending a test data package from the sending end to the receiving end;
E. checking whether step 4 is successful, and lowering and updating the transmission protocol value and returning to step 3 if it is not successful or continuing to the next step otherwise; and
F. starting data transmission, which starts to send data packages from the sending end to the receiving end using the transmission Baud rate determined by the transmission protocol value.

2. The method of claim 1, wherein step A sets equal the initial Baud rates of the sending end and the receiving end.

3. The method of claim 2, wherein the initial Baud rate is a lowest transmission Baud rate allowed by hardware.

4. The method of claim 3, wherein the lowest transmission Baud rate is 38.4K.

5. The method of claim 1, wherein the transmission protocol value set in step B is a highest transmission Baud rate allowed by hardware.

6. The method of claim 1, wherein step C further comprises the steps of:
C-1. sending an information package that contains the transmission protocol value from the sending end to the receiving end;
C-2. responding the sending end successful setting information after the receiving end correctly receives the information package; and
C-3. resetting the transmission protocol value as the current transmission Baud rates of the sending end and the receiving end.

7. The method of claim 1, wherein step E further comprises the steps of:
E-1. responding successful data transmission information to the sending end after the receiving end receives the test data package correctly and continuing to step F; and
E-2. resetting the transmission Baud rate of the sending end and the receiving end to the initial Baud rate (38.4K) if the sending end does not receive successful data transmission information from the receiving end within a predetermined waiting time (time out), then lowering and updating the transmission protocol value and returning to step C.

8. The method of claim 1, wherein step F further comprises the step of using a usual cyclical redundancy check (CRC) method to check the correctness of transmitted data packages.
